(19) United States
(12) Patent Application Publication
(10) Pub. No.: US 2009/0026758 A1
(43) Pub. Date: Jan. 29, 2009

(54) TUBE FITTING WITH INDICATION OF FIT

(76) Inventor: Brian D. Sanzone, Novi, MI (US)

Correspondence Address: Masco Corporation, 21001 Van Born Road, Taylor, MI, 48480, US

(21) Appl. No.: 11/781,989

(22) Filed: Jul. 24, 2007

(51) Int. Cl. F16L 35/00; F16L 19/06

(52) U.S. Cl. 285/93; 285/343

(57) ABSTRACT

A tube fitting includes a fitting body and a fitting member for receiving an end of a tube. The fitting member is movable relative to the fitting body between a first position and a second position. The fitting member and the fitting body cooperate to provide an audible indication of movement between the first position and the second position.

### BACKGROUND OF THE INVENTION

This invention relates to tube fittings and, more particularly, to tube fittings that provide an indication of a desired fit between a tube and the fitting.

Tube fittings are commonly known and used in plumbing, automotive, and other industries for attaching valves, joints, or other types of mechanisms to an end of a tube. Typically, a tube is cut or formed to a desired length, and an end of the tube is then received onto a male part within the tube fitting. A retainer, such as a clip, is then fastened about the end of the tube. The retainer compresses the end of the tube on the male part to lock the tube and tube fitting together.

To prevent leaking, it is generally desirable to provide a proper fit between the tube fitting and the tube such that o-rings or other sealing surfaces properly mate and seal. However, with some conventional tube fittings it is not evident that the tube has been properly received by the tube fitting because the end of the tube is not visible within the tube fitting. For example, the tube may be misaligned relative to the tube fitting, or the tube may not be completely received onto the male part. The resulting improper fit may lead to incomplete sealing and leaking.

Accordingly, there is a need for a tube fitting that provides an indication of a proper or desired fit between a tube and the tube fitting.

### SUMMARY OF THE INVENTION

An example tube fitting includes a fitting body and a fitting member for receiving an end of a tube. The fitting member is movable relative to the fitting body between a first position and a second position. The fitting member and the fitting body cooperate to provide an audible indication of movement between the first position and the second position.

In another aspect, the fitting body and the fitting member also cooperate to provide a visual indication of the first position and the second position.

An example method for verifying a desired fit between the tube and the tube fitting includes receiving the tube into the fitting member, moving the fitting member relative to the fitting body between a first position and a second position, and establishing the audible indication of the movement to indicate a desired fit between the tube and the tube fitting.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 illustrates an exploded view of an example tube fitting.

FIG. 2 illustrates the example tube fitting in a first position.

FIG. 3 illustrates the example tube fitting in a second position.

FIG. 4 illustrates a perspective view of the tube fitting in the second position.

### DETAILED DESCRIPTION OF THE PREFERRED EMBODIMENT

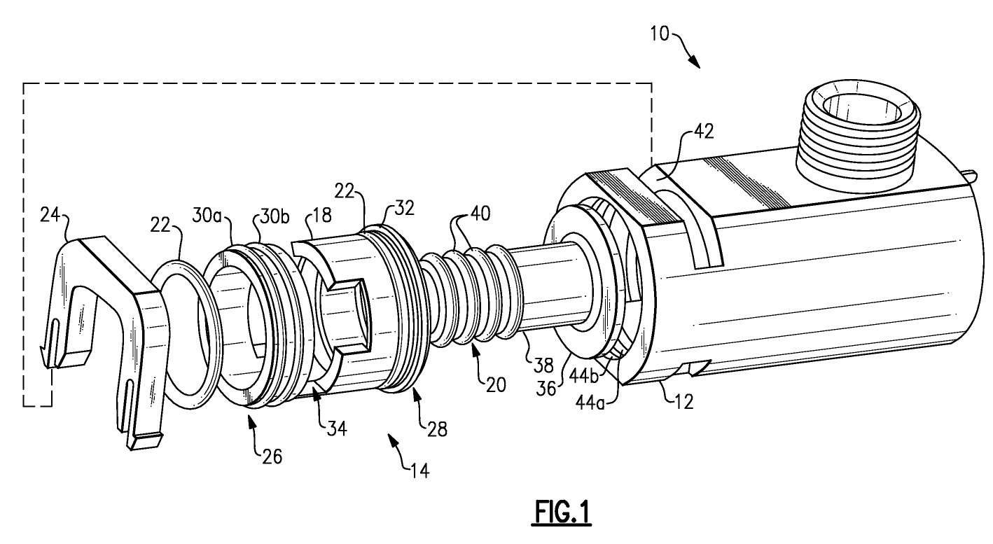

FIG. 1 is an exploded view illustrating selected portions of an example tube fitting 10 for use in plumbing, automotive, or other fields. In the disclosed example, the tube fitting 10 provides an indication of a desired fit between a tube and the tube fitting 10.

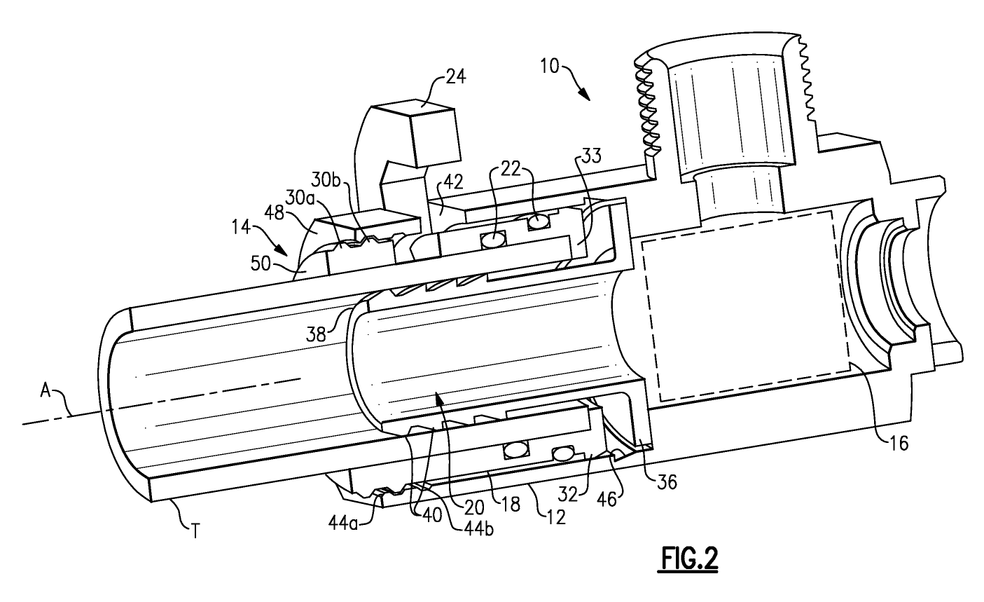

In this example, the tube fitting 10 includes a housing 12 that receives an attachment mechanism 14 for securing a tube and the tube fitting 10 together. Referring also to FIG. 2, the housing 12 in this example accommodates a valve 16 (shown schematically) for controlling a flow of fluid through the tube T and tube fitting 10. Optionally, no valve is used. Given this description, one of ordinary skill in the art will recognize that any of a variety of different valves may be used, and that other types of mechanisms may alternatively be used.

The attachment mechanism 14 includes a fitting member 18, a tube support 20, o-rings 22, and a retainer clip 24. In the disclosed example, the fitting member 18 is a sleeve structure that includes a first end 26 and a second end 28. The first end 26 includes ribs 30a and 30b and the second end 28 includes a lip 32 that protrudes outwards from the surface of the fitting member 18. A wall 33 extends inwards from the second end 28, and a central section between the ends 26 and 28 includes a slot 34 that extends partially about the circumference of the fitting member 18.

The tube support 20 includes a circular base 36 and a cylindrical section 38 that extends in a direction that is approximately perpendicular to the plane of the circular base 36. In the disclosed example, the cylindrical section 38 includes a plurality of teeth 40 that extend circumferentially about the cylindrical section 38. As can be appreciated in FIG. 2, the cylindrical section 38 is concentric with the fitting member 18 and the main portion of the housing 12. That is, the cylindrical section 38, the fitting member 18, and the housing 12 are concentric about a centerline axis A.

In the disclosed example, the tube fitting 10 includes two of the o-rings 22. One of the o-rings 22 fits about a periphery of the second end 28 of the fitting member 18. The other o-ring 22 fits within an inner diameter of the fitting member 18. The o-rings 22 collectively provide a seal between the housing 12 and the fitting member 18, and between a tube T and the fitting member 18. Given this description, one of ordinary skill in the art will recognize that a different number of o-rings 22 than in the given example may be used, depending on the sealing needs of a particular tube fitting.

The retainer clip 24 is used to secure the tube T and the tube fitting 10 together. The housing 12 includes a slot 42 for receiving the retainer clip 24. The slot 42 corresponds to the slot 34 of the fitting member 18. When the slots 34 and 42 are axially aligned, the clip 24 is permitted to be received into the housing 12 to secure the tube T and the tube fitting 10 together.

In addition to the slot 42, the housing 12 includes grooves 44a and 44b that correspond to the ribs 30a and 30b. Additionally, the housing 12 includes a locking groove 46 that corresponds to the lip 32 of the fitting member 18 for locking the fitting member 18 within the housing 12.

FIG. 2 illustrates the tube T partially received within the tube fitting 10. That is, the tube T has been inserted into the tube fitting 10 but is not yet locked and in a fully installed position. As illustrated, the fitting member 18 is in a first position relative to the housing 12. In the first position, the rib 30b is located within groove 44a of the housing 12. Interlocking between the rib 30b and the groove 44a limits movement of the fitting member 18 relative to the housing 12 until an assembly force is applied. In other examples, the first position may be different than illustrated in this example, such that the rib 30b is not engaged with the groove 44a.

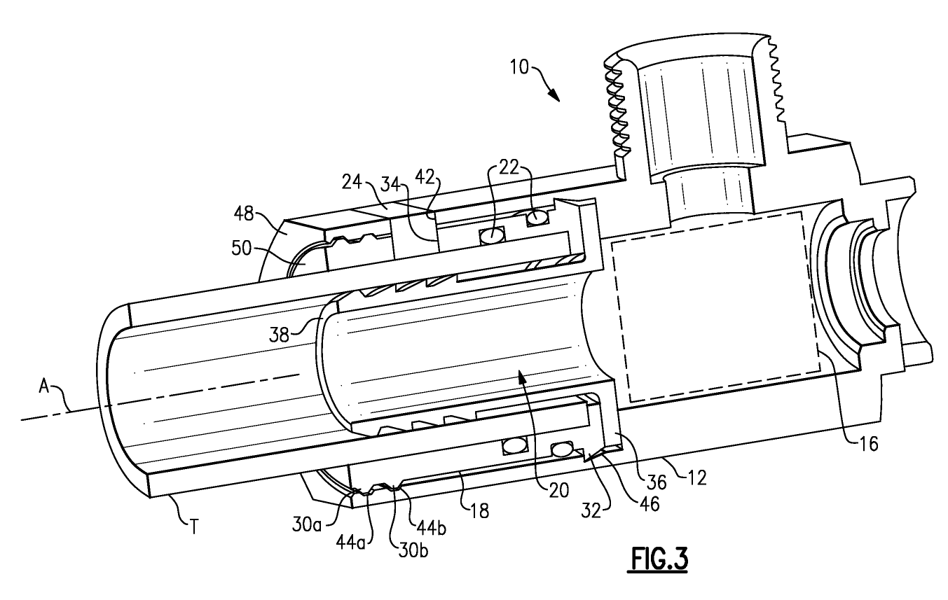

An installation force applied to the tube T or to the housing 12 is transferred through the wall 33 and through the fitting member 18 to overcome the interference fit between the rib 30b and the groove 44a. As the tube T is inserted into the tube fitting 10 (to the right in FIG. 2), the tube T abuts the wall 33 of the fitting member 18. The fitting member 18 then moves to a second position (FIG. 3) relative to the housing 12 such that the rib 30b slides into groove 44b, the rib 30a slides into grove 44a, and the lip 32 slides into locking groove 46 to lock the fitting member 18 and the housing 12 together, as shown in FIG. 3. In other examples, there may be other desired relative positions between the ribs 30a and 30b and the grooves 44a and 44b, or the first and second positions may be based on relative positions between other features of a fitting.

In the illustrated example, the o-ring 22 on the outside of the fitting member 18 seals against the inner diameter of the housing 12, and the other o-ring that is inside of the fitting member 18 seals against the outer diameter of the tube T when in the second position.

Movement of the fitting member 18 relative to the housing 12 from the first position shown in FIG. 2 to the second position shown in FIG. 3 causes an audible indication of the movement between the positions. That is, the interference between the ribs 30a and 30b and the grooves 44a and 44b causes an audible sound that indicates movement from the first position to the second position. In some examples, the movement of the lip 32 into the locking groove 46 may also audibly contribute to indicating the movement.

In the disclosed example, the second position also corresponds to a fully installed and proper position of the tube T and the fitting member 18 relative to the housing 12. Thus, a user would have verification that the tube T is in a proper and desired position.

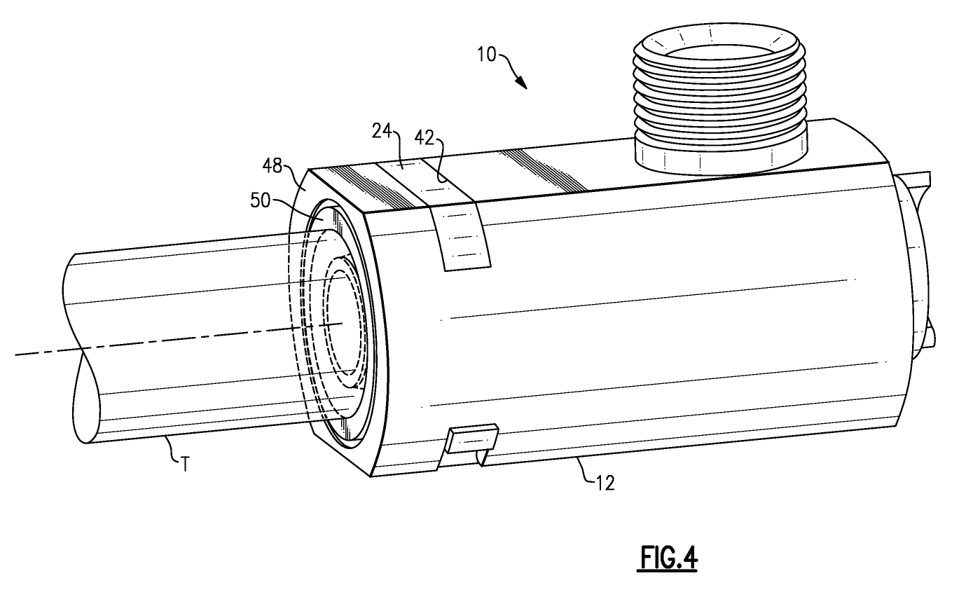

Referring to FIG. 4, the tube fitting 10 optionally also provides a visual indication of the proper fit. The housing 12 includes a first indicator surface 48 and the fitting member 18 includes a second indicator surface 50. In the first position, the first indicator surface 48 and the second indicator surface 50 are non-flush (FIG. 2). The non-flush orientation provides a visual indication to a user that the tube T is not installed in the proper position. In the second position (FIG. 3), the first indicator surface 48 and the second indicator surface 50 are approximately flush. The flush orientation provides a visual indication that the tube T is in the proper position. In some examples, the surfaces 48 and 50 may not be exactly flush but they are they visually appear to be flush. Thus, the tube fitting 10 of the disclosed examples may also provide the benefit of dual verification of a proper fit between the tube T and the tube fitting 10.

In the second position, the slot 34 of the fitting member 18 and the slot 42 of the housing 12 are aligned such that the retainer clip 24 is permitted to be received within the slots 34 and 42. The retainer clip 24 compresses the tube T about the cylindrical section 38 of the tube support 20 to further secure the tube T and the tube fitting 10 together. Given this description, one of ordinary skill in the art will recognize that other types of retainers or securing mechanisms may be used. Further, alignment of the slots 34 and 42 may provide another visual indication that the tube T is properly installed in the tube fitting 10.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A tube fitting comprising:
a fitting body; and
a fitting member for receiving an end of a tube, the fitting member being moveable relative to the fitting body between a first position and a second position, the fitting member and the fitting body cooperating to provide an audible indication of movement between the first position and the second position.

2. The tube fitting as recited in claim 1, wherein the first position corresponds to an uninstalled position of the tube and the second position corresponds to a fully installed position of the tube.

3. The tube fitting as recited in claim 1, wherein the fitting member comprises a sleeve and the fitting body comprises a housing that at least partially surrounds the sleeve.

4. The tube fitting as recited in claim 3, wherein one of the sleeve or the housing includes at least one rib and the other of the sleeve or the housing includes at least one groove for cooperating with the at least one rib to provide the audible indication.

5. The tube fitting as recited in claim 4, wherein the sleeve includes the at least one rib and the housing includes the at least one groove.

6. The tube fitting as recited in claim 4, wherein the at least one rib includes a first rib and a second rib that each extend circumferentially about a periphery of the sleeve, and the at least one groove includes a first groove and a second groove that each extend circumferentially about an internal surface of the housing.

7. The tube fitting as recited in claim 4, wherein the at least one rib is located near a first end of the sleeve and the sleeve includes a second, opposite end having a protruding lip for locking the sleeve and the housing together.

8. The tube fitting as recited in claim 3, further including a tube support for receiving the tube thereon, wherein the tube support includes a cylindrical section that is concentric with the sleeve and the housing.

9. The tube fitting as recited in claim 1, further comprising a valve mechanism at least partially within the fitting body.

10. The tube fitting as recited in claim 1, wherein the fitting body and the fitting member cooperate to provide a visual indication the first position and the second position.

11. The tube fitting as recited in claim 1, further comprising a retainer for securing the fitting body and the fitting member together.

12. The tube fitting as recited in claim 1, wherein the fitting body includes a first slot and the fitting member includes a second slot, and the first slot and the second slot are non-aligned in the first position and aligned in the second position.

13. A tube fitting comprising:
a fitting body; and
a fitting member for receiving an end of a tube, the fitting member being moveable relative to the fitting body between a first position and a second position, and the fitting member and the fitting body cooperating to provide an audible indication of movement between the first position and the second position and a visual indication of the first position and the second position.

14. The tube fitting as recited in claim 13, wherein one of the fitting member or the fitting body includes at least one rib and the other of the fitting member or the fitting body includes at least one groove that cooperates with the at least one rib to provide the audible indication.

15. The tube fitting as recited in claim 13, wherein the fitting body comprises a first indicator surface and the fitting member includes a second indicator surface, and a relative proximity between the first indicator surface and the second indicator surface provides the visual indication.

16. The tube fitting as recited in claim 15, wherein the first indicator surface and the second indicator surface are non-flush in the first position and flush in the second position.

17. The tube fitting as recited in claim 16, wherein the first indicator surface and the second indicator surface are within a plane in the second position, and the plane is perpendicular to a central axis of the tube fitting.

18. A method of verifying a desired fit between a tube end and a tube fitting that includes a fitting member that is moveable relative to a fitting body, comprising:
(a) receiving the tube into the fitting member;
(b) moving the fitting member relative to the fitting body between a first position and a second position; and
(c) establishing an audible indication of movement between the first position and the second position to indicate a desired fit between the tube end and the tube fitting.

19. The method as recited in claim 18, further including moving a rib on at least one of the fitting member or the fitting body relative to a groove on the other of the fitting member or the fitting body to provide the audible indication.

20. The method as recited in claim 18, further including establishing a visual indication of the first position and the second position.
